(19) United States
(12) Patent Application Publication
(10) Pub. No.: US 2009/0297119 A1
(43) Pub. Date: Dec. 3, 2009

(54) INFORMATION RECORDING AND REPRODUCING APPARATUS

(76) Inventors: Masakazu TAKAMORI, Yokohama (JP); Yasunori Ohara, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/430,225

(22) Filed: Apr. 27, 2009

(30) Foreign Application Priority Data
May 30, 2008 (JP) 2008-141865

(51) Int. Cl. H04N 5/91; H04N 5/93; H04N 5/00

(52) U.S. Cl. 386/52; 386/95; 386/126; 386/E05.003; 386/69

(57) ABSTRACT

An information recording and reproducing apparatus which allows a user to easily grasp the progress status of a dubbing process when video data is dubbed from a recording medium to other recording medium and which also clearly indicates that the dubbing process is running. Here, in a screen display while video data is dubbed to other recording medium, the image of the video data portion currently being dubbed is thumbnailed. Furthermore, the displayed thumbnail is switched at each scene or at predetermined time intervals, thereby facilitating a check on the progress status of the dubbing process and also allowing for confirmation that the dubbing process is running.

### INCORPORATION BY REFERENCE

The present application claims priority from Japanese application JP 2008-141865 filed on May 30, 2008, the content of which is hereby incorporated by reference into this application.

### BACKGROUND OF THE INVENTION

The present invention relates to information recording and reproducing apparatuses.

JP-A-2002-100168 (Patent Document 1) describes as a problem to be solved that “To clarify which program is recorded in which order in the case where a large number of programs are recorded on a large-capacity recording medium, thereby reproducing and dubbing the desired programs in a desired order with simple manipulation.” and also describes as a solution thereof that “In recording a plurality of video contents in an HD, thumbnails of the respective video contents that can be displayed on a TV screen are prepared and stored in the HD and then in reproducing the plurality of video contents recorded in the HD, the thumbnails are output and displayed on the TV screen so that a user can specify the video contents to reproduce and the order of reproduction, and then the specified video contents are reproduced in the specified order.” (See the abstract of Patent Document 1.)

JP-A-2005-210177 (Patent Document 2) describes as a problem to be solved that “To perform dubbing from a tape type recording medium to a disc type recording medium with good operability and efficiency.” and also describes as a solution thereof that “A recording and reproducing apparatus comprises: a signal extracting unit that extracts a reference image signal for displaying a reference image, at predetermined time intervals in the reproduction time axis, among the image signals recorded on a magnetic tape; a memory for storing the extracted reference image signal; a reading unit that can read the reference image signal stored in the memory for the purpose of displaying the reference signal image; and an input unit capable of externally inputting an operation instruction on the dubbing operation from the tape type recording medium to the disc type recording medium after the reference image is displayed.” (See the abstract of Patent Document 2.)

JP-A-2007-18599 (Patent Document 3) describes as a problem to be solved that “To provide a recording and reproducing apparatus which accepts an instruction to reproduce information (e.g., a videotaped program) being dubbed at a high speed and which then reproduces the information based on the accepted reproduce instruction, thereby reproducing a program being dubbed at a high speed even if being dubbed at a high speed, and a recording and reproducing method.” and also describes as a solution thereof that “When a CPU accepts a reproduction request while the videotaped program is dubbed at a high speed from an HDD to a DVD, the CPU specifies a reproduction start position based on a time stamp of a packet that constitutes a video voice stream during dubbing at a high speed at a time point when there is the reproduction request.” (See the abstract of Patent Document 3.)

### SUMMARY OF THE INVENTION

One of the information recording apparatuses is a video camera. In recent years, in consumer video cameras, the incorporated recording medium has shifted to a disc medium because users are unlikely to overwrite or users can easily search images, for example. An optical disc such as a DVD or a hard disc is used as the disc medium. Furthermore, efforts are being made to increase the capacity of the recording medium and provide a high-quality image recording method so that the video cameras can record high-quality images for an extended period of time.

As the high-capacity optical disc, the next-generation optical disc called BD (Blu-ray Disc) formulated by BDA (Blu-ray Disc Association) and an HD-DVD defined by the DVD forum have come into the market. These discs are capable of recording not only the conventional standard definition (SD) mode video but also the high-definition (HD) mode video without changing the respective data formats.

On the other hand, recently, a hybrid video camera provided with both an HDD (Hard Disc Drive) and an optical disc drive has been developed, and here, for example, by incorporating the HDD and the optical disc drive in the hybrid video camera, images picked up and stored in the HDD can be easily dubbed to an optical disc without using video cable connection, a personal computer, or the like, and a lot of studies on the method of dubbing high-quality images to a portable removable disc are also being made.

As in the above-described Patent Documents 1 to 3, various kinds of measures for improving the usability of a user are employed in the dubbing-start operation in the information recording and reproducing apparatuses.

However, once the apparatus has actually started the dubbing process, it takes a lot of time until the dubbing process is complete. In particular, as described above, in recent years, high-quality images are more often handled and for this reason the dubbing time also tends to increase, and therefore, as the statuses that are meanwhile displayed on a display screen, a progress bar indicative of the progress of the process, the progress percentage, the remaining time of the process, and the image currently being processed are enumerated.

For example, when video data of a first high definition encoding/compression scheme that is recorded on an HDD is transcoded into images of a second encoding/compression scheme and dubbed to an optical disc, an encoding processor for compressing an image and a decoding processor for restoring the compressed image can be simultaneously operated during dubbing operations in a dubbing apparatus such as a recorder, and therefore, the decoded reproduced-images are displayed and at the same time the progress bar or the percentage of the progress is displayed, thereby providing information during dubbing operations to a user.

However, in dubbing using a mobile apparatus such as a video camera, it is difficult to simultaneously operate the encoding processor and the decoding processor as described above because of a limit on the transfer rate or a limit on a control processor due to the power or the like of a CPU's memory, and it is impossible to display the decoded reproduced-images, for example. For this reason, the information provided to a user is only an indication of the progress bar or the percentage of the progress. It is thus difficult for a user to know the progress status only with such indication, and for example, in dubbing in an apparatus having a dubbing interrupt function, it is not easy for a user to interrupt the dubbing at a position which the user desires to interrupt.

In particular, in the case of dubbing using a transcoding process, it takes a lot of time as compared with a case where the dubbing is performed using a copy method. For this reason, there may be no change in the progress bar or the progress percentage indication for a long time. For a user, whether or not the apparatus is operating correctly during dubbing is usually determined by the screen display, and if there is not much progress in the screen display, a user might feel uneasy about the operation, i.e., about whether or not the dubbing is progressing.

Since only one screen can be displayed during dubbing in the conventional display screen, the information obtained by a user during dubbing is biased.

In view of the above-described problems, the present invention is intended to improve the usability of a user during dubbing by use of a simple configuration.

The above-described problems can be improved, for example, in an information recording and reproducing apparatus, by preparing a first display screen for displaying thumbnails corresponding to a plurality of image information to be dubbed and a second display screen for displaying a thumbnail whose corresponding image information is currently being recorded by dubbing so that the first display screen and the second display screen can be switched and displayed during dubbing process.

According to the present invention, the usability of a user during dubbing in the information recording and reproducing apparatus can be improved.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an outline of a video camera in first and second embodiments of the present invention.

FIG. 2 is a block diagram showing an outline of an encoding/decoding processor in the first embodiment of the present invention.

FIG. 3 is a view showing an example of a display screen in selecting a dubbing scene in the first and second embodiments of the present invention.

FIG. 4 is a view showing a display screen during dubbing.

FIG. 5 is a view showing a display screen during dubbing.

FIG. 6 is a view showing an example of a display screen when dubbing interruption is selected.

FIG. 7 is a view showing an example of a display screen during dubbing.

FIG. 8 is a view showing an example of a display screen during dubbing.

FIG. 9 is a flowchart showing operations from power ON to power OFF in the second embodiment of the present invention.

FIG. 10 is a view showing a display screen during dubbing in the second embodiment of the present invention.

### DESCRIPTION OF THE EMBODIMENTS

The preferred embodiments of the present invention will be described using the accompanying drawings.

### First Embodiment

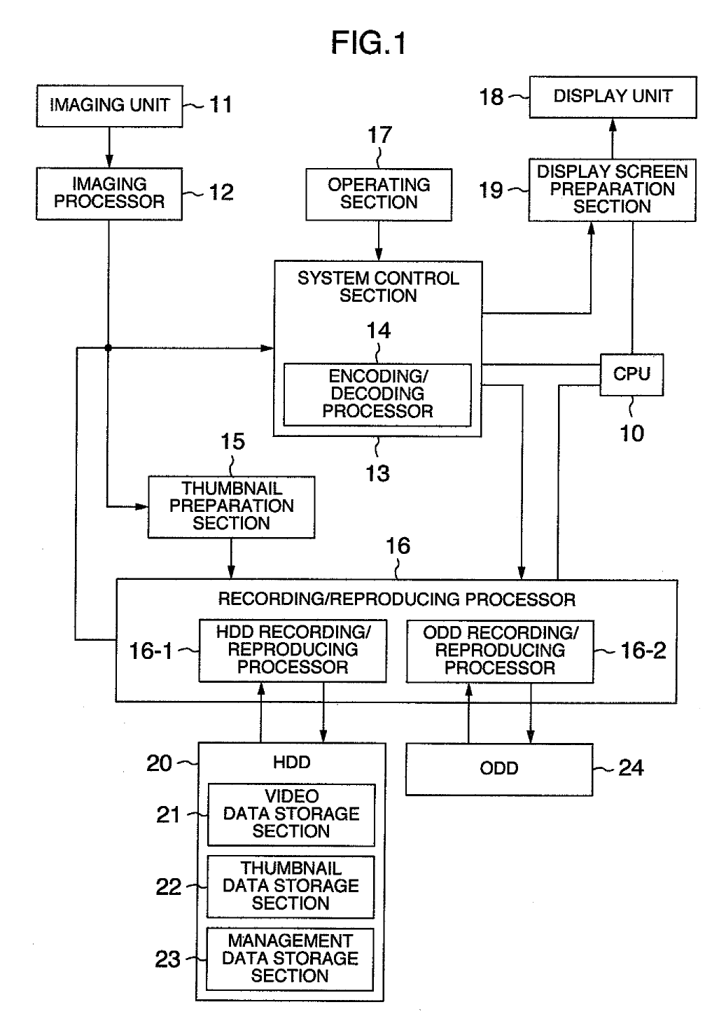

A first embodiment of the present invention is described with reference to FIG. 1. FIG. 1 is a block diagram showing a configuration of a portion related to the present invention of a hybrid type video camera provided with two recording media, showing an embodiment of the present invention. In this embodiment, a video camera will be described as an example, however, the configuration and effects of the present invention are not limited thereto, but can be applied to other information recording and reproducing apparatuses, for example, such as a desktop video recorder.

In FIG. 1, reference numeral 10 represents a CPU, 11 represents an imaging unit, 12 represents an imaging processor, 13 represents a system control section, 14 represents an encoding/decoding processor, 15 represents a thumbnail preparation section, 16 represents a recording/reproducing processor, 16-1 represents an HDD recording/reproducing processor, 16-2 represents an ODD recording/reproducing processor, 17 represents an operating section, 18 represents a display unit, 19 represents a display screen preparation section, 20 represents a hard disc drive (HDD), 21 represents an image data storage area, 22 represents a thumbnail data storage area, 23 represents a management data storage area, and 24 represents an optical disc drive (ODD).

This embodiment shown in FIG. 1 shows an example applied to a hybrid camera provided with the HDD 20 and the ODD 24. This hybrid camera includes a hard disc of the HDD 20 and an optical disc of the ODD 24 as the recording media, wherein a DVD or a BD is used as the optical disc of the ODD 24 and is removable. A motion picture that was compressed in accordance with MPEG (Moving Picture Expert Group) standards is recorded in these HDD 20 and ODD 24.

Next, the recording operation of this embodiment is described. Here, a case where images are recorded in the HDD 20 is described as an example. Note that, this embodiment will be described using the HDD and the optical disc as the recording media, but not limited thereto, and the present invention can be also applied to a combination of other recording media, for example, such as a semiconductor memory.

The imaging unit 11 comprises an optical lens for imaging an object and a CCD sensor or CMOS sensor that converts the resulting image into an electric signal, and the electric signal converted here is converted to a digital video signal by the imaging processor 12. The digital video signal supplied from the imaging processor 12 is subjected to compression processing conforming to the MPEG standards in the encoding/decoding processor 14 in the system control section 13, resulting in MPEG video data, which is then supplied to the HDD recording/reproducing processor 16-1 in the recording/reproducing processor 16. Moreover, this digital video signal is also supplied to the thumbnail preparation section 15, which then prepares thumbnail data using a head image of a video scene comprising a series of digital video signals and also prepares management information on the series of digital video signals and supplies this information to the HDD recording/reproducing processor 16-1 in the recording/reproducing processor 16. The HDD recording/reproducing processor 16-1 in the recording/reproducing processor 16 combines the MPEG video data and thumbnail data and its management data and supplies this to the HDD 20. In the HDD 20, the MPEG video data is recorded in the video data recording area 21, the thumbnail data is recorded in the thumbnail data recording area 22, and the management data is recorded in the management data storage area 23. Here, although each function of the system control section 13 or the encoding/decoding processor 14 can be preferably realized by executing programs by a microprocessor, a part or all of the function may be constructed in hardware.

On the other hand, the digital video signal supplied from the imaging processor 12 is also supplied to the display screen preparation section 19 without via the encoding/decoding processor 14 in the system control section 13, and then is added by text information or the like in the display screen preparation section 19, and the resulting signal is sent to the display unit 18 for confirming images being picked up. Start or termination of the recording operation to the HDD 20 is performed by a user pressing a recording button of the operating section 17. The system control section 13 controls the imaging unit 11, the imaging processor 12, the thumbnail preparation section 15, and the recording/reproducing processor 16, and the like.

Next, the reproducing operation of this embodiment is described. Here, a case where video data recorded in the HDD 20 is reproduced is described as an example.

Reproducing process is started by pressing a reproduction button of the operating section 17. Upon start of reproduction, the system control section 13 controls the HDD recording/reproducing processor 16-1 in the recording/reproducing processor 16 and supplies MPEG video data of a video scene specified by a user to the encoding/decoding processor 14 in the system control section 13. The supplied data is decoded into the original video data. This decoded video data is supplied to the display screen preparation section 19, where icons or the like indicating the scene number, the date, the conditions of the camera are arranged on the video data and displayed as a reproduced image in the display unit 18.

Next, the dubbing operation of this embodiment is described.

In this embodiment, when the MPEG video data recorded in the HDD 20 is dubbed to the optical disc in the ODD 24, the following two methods are possible: a method of dubbing the MPEG video data with the “as-is” recording form without changing the compressed format; and a method (called “transcode dubbing”) of converting the recording format of the MPEG video data into that of the optical disc of the dubbing destination by using a transcoding function of the encoding/decoding processor 14. As an example of the transcode dubbing, an HD video is recorded in the HDD 20 in + the H.264 format, and then the recording format is converted into the MPEG2 format and also the resolution (rate) is converted to the SD mode, so that the HD video can be dubbed to the optical disc.

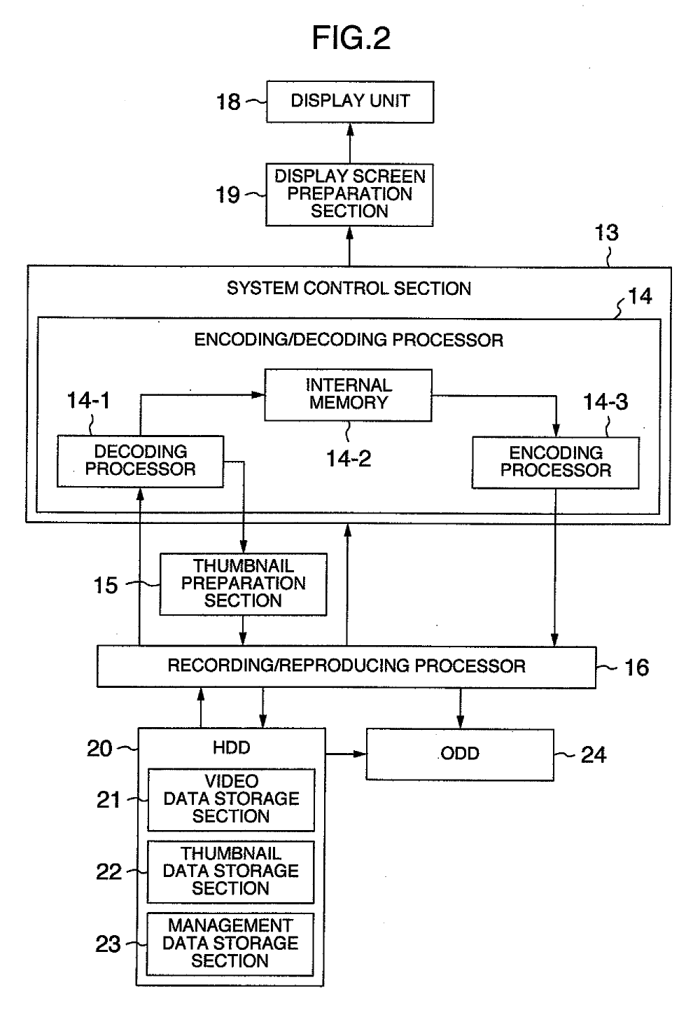

FIG. 2 is a block diagram for performing dubbing, including the detailed inside of the encoding/decoding processor 14 of FIG. 1.

Here, the operation in transcode-dubbing an HD-mode video signal recorded in the HDD 20 to the optical disc in the ODD 24 is described.

A plurality of video scenes of the HD mode are recorded in the H.264 format in the image data storage area 21 of the HDD 20. This video data of the H.264 format is supplied to the decoding processor 14-1. The supplied video data is decoded by the decoding processor 14-1, and is temporarily stored in the internal memory 14-2. After a specified amount of data is stored in the internal memory 14-2, this stored data is supplied to the encoding processor 14-3. In the encoding processor 14-3, the supplied data is encoded into data of the SD mode for the DVD. This encoded data is written to the optical disc in the ODD 24 serving as the dubbing destination. By repeating these series of operations and writing all the data of a scene to be dubbed from HDD 20 of the dubbing source to DVD, the dubbing is complete.

Every time the scene of data to be processed changes during this dubbing operation, a thumbnail that is a head screen image of the scene is supplied from the thumbnail data storage area 22 in the HDD 20 to the display screen preparation section 19 via the recording and reproducing processor 16, where other information (the percentage of the progress, the bar indicator indicating the progress, or the like) during dubbing is added to the thumbnail, and the resulting information is displayed on the display unit 18. The details of the screen displayed in this case will be described later.

Moreover, the video data decoded by the decoding processor 14-1 may be supplied also to the thumbnail preparation section 15, and the head screen image in this supplied video data is prepared as a thumbnail, which is then stored in the thumbnail data storage area 22 of the HDD 20 via the recording and reproducing processor 16 so as to be displayed on the display unit 18 as described above.

Next, the method of dubbing in the “as-is” format without changing the compressed format is described. In the case of this dubbing method, by writing the MPEG video data of the video data storage area 21 of the HDD 20 to the optical disc in the ODD 24 without changing the compressed format, the dubbing is complete. In synchronization with the progress of writing, the thumbnail recorded in the thumbnail data storage area 22 in the HDD 20 will be displayed as described above. Moreover, in synchronization with the progress, the MPEG video data of the video scene is decoded by the decoding processor 14-1, and a thumbnail is prepared by the thumbnail preparation section 15 using the decoded image as the scene of the video currently being processed and is then displayed on the display unit 18 using the above-described process as in the transcode dubbing.

In the course of these two dubbing processes, by supplying video data to the decoding processor 14-1 at each predetermined time interval (e.g., 5 seconds, 10 seconds, etc.), the thumbnail to be displayed on the display unit 18 is updated so that a thumbnail close to the scene currently being dubbed is displayed.

Next, the operations until dubbing is started in this embodiment are described.

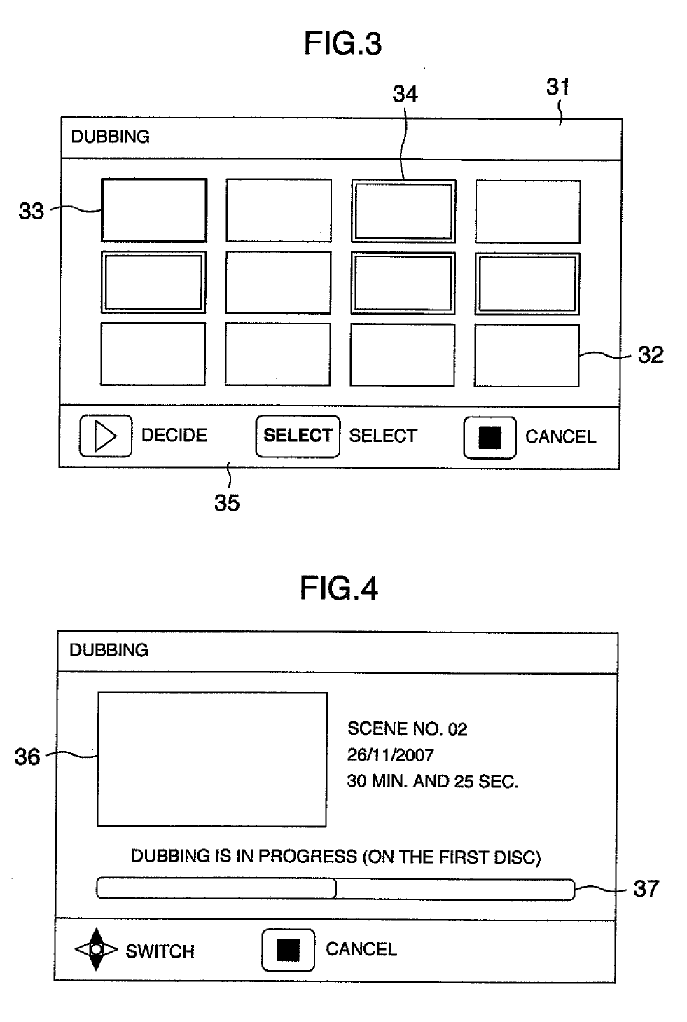

Upon depression of a dubbing button of the operating section 17, the display screen transitions to a screen for selecting a scene to dub. The screen for selecting a scene is shown in FIG. 3. The screen of FIG. 3 comprises a title bar 31, a thumbnail 32, a cursor 33, a selected cursor 34, and a guide bar 35.

For the thumbnail 32, the thumbnails recorded in the thumbnail data storage area 22 in the HDD 20 are arranged in the order of having been recorded. This thumbnail is the data that was recorded and stored at the same time as shooting, and these thumbnails are arranged in the order of having been recorded by use of the data stored in the management data storage area 23.

In this screen, a frame surrounding a thumbnail is shown as a cursor 33, which will moves across these thumbnails by operating a cursor key in the operating section 17. Moreover, the guide bar 35 includes icons for indicating keys in the operating section 17, the keys being available while this screen is displayed, and the description about the operation when the relevant key is pressed.

In this screen, when a user looks at thumbnails and determines a scene desired to dub and selects this scene as a scene to dub, the user moves the cursor 33 onto a thumbnail of the desired scene by manipulating the cursor key and then presses a selection button in the operating section 17. Upon depression of the selection button, the color of the cursor will change and turn into the selected cursor 34 that indicates a user that the scene has been selected. In dubbing a plurality of scenes, a thumbnail is selected by manipulating the cursor key and a scene desired to dub is selected with the selection button as described above and these operations will be repeated. In this case, on whichever thumbnail the cursor 33 lies, the thumbnail of a selected scene is surrounded by the selected cursor 34 so that the selected scene may be identified. When the selection of the scenes is done, dubbing is started by pushing a determination button in the operating section 17.

FIG. 4 shows a display screen during dubbing.

In this screen (hereinafter, referred to as a one-screen dubbing display), a title bar, a guide bar, a thumbnail 36 of a scene being dubbed, the detailed information on the scene being dubbed, a progress indication bar 37 indicating the progress of the entire dubbing are displayed.

The thumbnail 36 and the detailed information are updated every time the scene being dubbed has changed. Moreover, the thumbnail 36 is updated at each predetermined time interval (e.g., 5 seconds, 10 seconds, etc.), and the thumbnail 36 corresponding to a video scene which is currently being written to the optical disc is shown. Accordingly, the progress status of the dubbing process is more easily understood by a user. In this screen, since one thumbnail can be shown with a large screen, the user's visibility can be improved when the dubbing status needs to be confirmed on a small display screen as with a video camera. This allows a user to easily confirm the progress status of the dubbing process and thereby the convenience in dubbing can be improved.

Furthermore, in order to show the progress status of the dubbing, for example, a progress indication bar 37 for indicating the recording capacity of the optical disc and the recording capacity that has already been recorded to the optical disc by the dubbing process, an indication which, when the dubbing involves a plurality of optical discs, indicates that dubbing is being performed on which optical disc among the optical discs, an indication of information on the shooting date and time of the image information being recorded on the optical disc, and the like are displayed on the screen. Thereby, the progress status of the dubbing process is more easily understood by a user and the usability in dubbing can be improved.

While this screen is displayed, the cancel button in the operating section 17 is available and the dubbing operation can be interrupted by pressing the cancel button. A user makes a decision to interrupt dubbing with reference to the thumbnail 36 and the progress indication bar 37 as the basis for making this decision. This interrupt instruction can be issued by selecting a canceling menu in the lower part of this screen.

Moreover, on this screen, for example, a cursor up and down button or the like in the operating section 17 is also available, and the displays during dubbing can be switched.

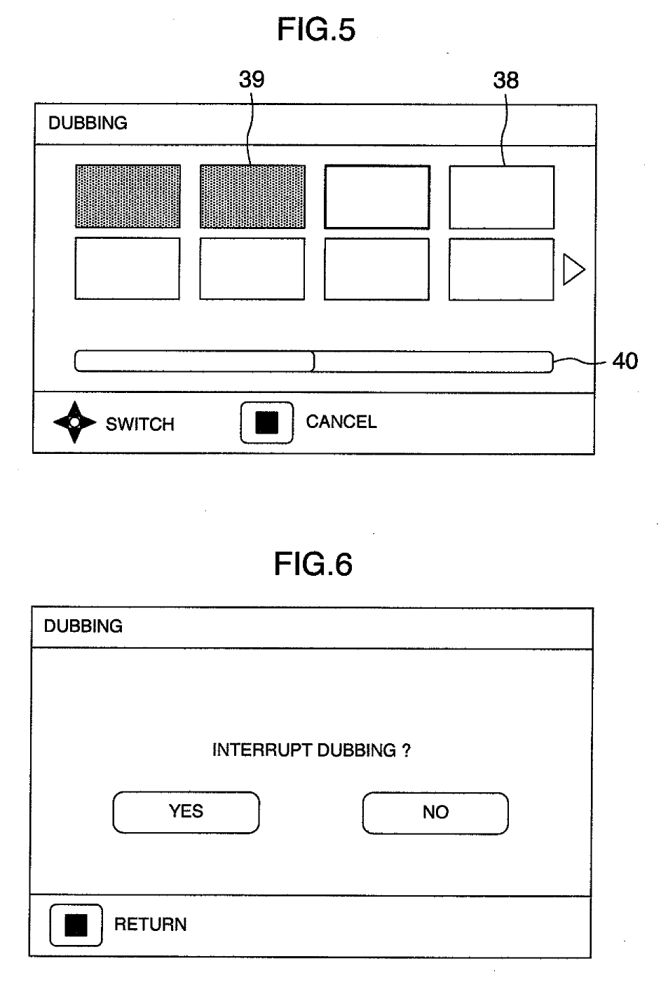

FIG. 5 shows, for example, a dubbing screen 2 when the dubbing screen has been switched by the up and down key or the like in the dubbing screen of FIG. 4. Moreover, it is also possible to transition to the dubbing screen of FIG. 4 again by manipulating the up and down key in this screen.

The screen (hereinafter, referred to as a multiple-screen dubbing display) of FIG. 5 comprises a title bar, a guide bar, a thumbnail 38 selected as a scene to dub in the screen of FIG. 3, and a progress indication bar for indicating the progress of the entire dubbing.

In this screen, all the scenes scheduled to be dubbed are displayed as thumbnails. As with the thumbnail 36 displayed in FIG. 4, the thumbnail 38 is also displayed using the data that was recorded at the same time as shooting and stored in the thumbnail data storage area 21 in the HDD 20. If the number of scenes to be dubbed exceeds the number of thumbnails that can be displayed in this screen, it is also possible to switch the thumbnail 38 to a non-displayed thumbnail using a left and right button of a cursor in the operating section 17.

The thumbnail 38 of a scene whose dubbing process has been completed is subjected to further processing for indicating until which scene the dubbing process has been completed in the entire dubbing processes. Here, a mark or the like indicative of the completion of the dubbing process may be put on the thumbnail 38. For example, a semi-transparent black mask 39 is put on the thumbnail of a scene whose dubbing process has been completed, thereby indicating that the dubbing process of the scene of this thumbnail is complete.

Moreover, the thumbnail 38 of a scene currently being dubbed is encircled by a cursor and shown as the scene currently being processed.

For the thumbnail 38 current being processed, if a thumbnail in the middle of a scene is newly generated through the decoding processor 14-1 during dubbing process, the thumbnail is newly updated. In this screen, since the progress status of the entire dubbing processes can be confirmed, a user can grasp the whole picture of the dubbing status and accordingly the convenience in dubbing can be improved.

FIG. 6 shows a dubbing interrupt confirmation screen that is displayed when the cancel button in the operating section 17 in the screen of FIG. 4 or FIG. 5 is pressed or when the canceling menu is selected. In this screen, a user is asked for his/her final decision whether or not the dubbing interruption is performed. If “yes” is selected, the dubbing operation is stopped at the point where the dubbing has been performed up to now. If “No” or the cancel button is pressed, the screen of FIG. 4 or FIG. 5 is displayed again and the dubbing process will be continued.

As described above, according to this embodiment, in dubbing the video data present in the HDD 20 to the optical disc in the ODD 24, the thumbnails can be displayed on the display unit 18 and accordingly the convenience for a user can be improved.

In this way, even when the internal operation is limited during dubbing due to a limit on the system such as the video camera, as in the above-described embodiment, it is possible to display and update the thumbnails while dubbing and let a user to know that the dubbing process is being performed, and it is also possible to report the current dubbing portion in more detail, so the usability will be improved.

Moreover, by providing a unit that switches between the one-screen dubbing display and the multiple-screen dubbing display, a user can take advantage of the both displays and can perform the dubbing comfortably.

In the above embodiment, a case where images recorded in the HDD are dubbed to the optical disc using the hybrid camera has bee described, however, this embodiment is also possible even when the ODD of the dubbing destination is connected to the video camera. Moreover, this embodiment is effective even when the media of the dubbing source and the dubbing destination differ from each other.

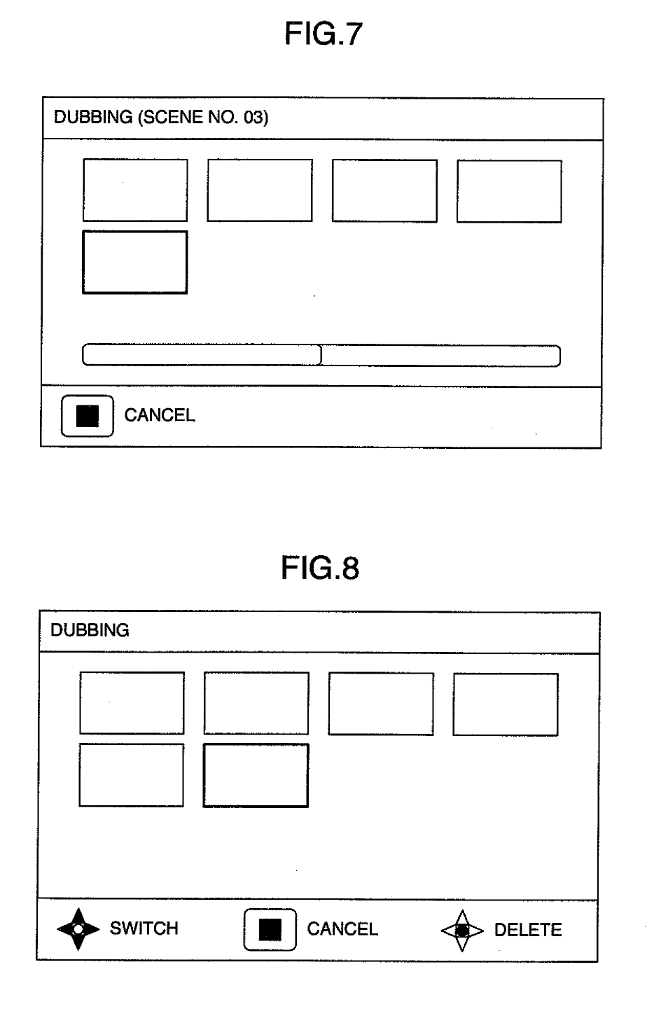

In the above embodiment, as an example of displaying thumbnails during dubbing, FIG. 4 or FIG. 5 has been described, however, for example, a display method comprising a step of displaying the thumbnail of a scene whose dubbing process has been completed and a thumbnail of a scene currently being dubbed; and a step of adding a thumbnail on the display whenever the one scene dubbing is complete is also possible. Moreover, in this method, a display method of adding only a thumbnail that has been displayed in one scene to the completed thumbnails is also possible. For example, when a screen of FIG. 7 is displayed, a scene 3 is currently being dubbed and the scenes whose dubbing has been completed are indicated with five thumbnails. In this case, if there are two or more scenes that are specified to be dubbed, then the screen will transition in such a manner that upon completion of the dubbing of one scene, the thumbnail currently being displayed is deleted and a thumbnail of the next scene is displayed, for example. This embodiment makes it possible to tell a user about the progress of dubbing in more detail.

FIG. 8 is a display example when a thumbnail generated at predetermined time intervals and a thumbnail of a head picture of a scene are sequentially added, as an example of displaying thumbnails during dubbing. This allows a user to confirm the image information during dubbing in more detail.

### Second Embodiment

A second embodiment of the present invention is described. The configuration when the second embodiment is applied to a video camera is shown in FIG. 1, as with the first embodiment. However, as with the first embodiment, the present invention is not limited to the video camera, but can be applied to other information recording and reproducing apparatuses, such as a desktop video recorder. Note that, this embodiment is described using the HDD and the optical disc as the recording media, but not limited thereto, and the present invention can be also applied to a combination of other recording media, for example, such as a semiconductor memory.

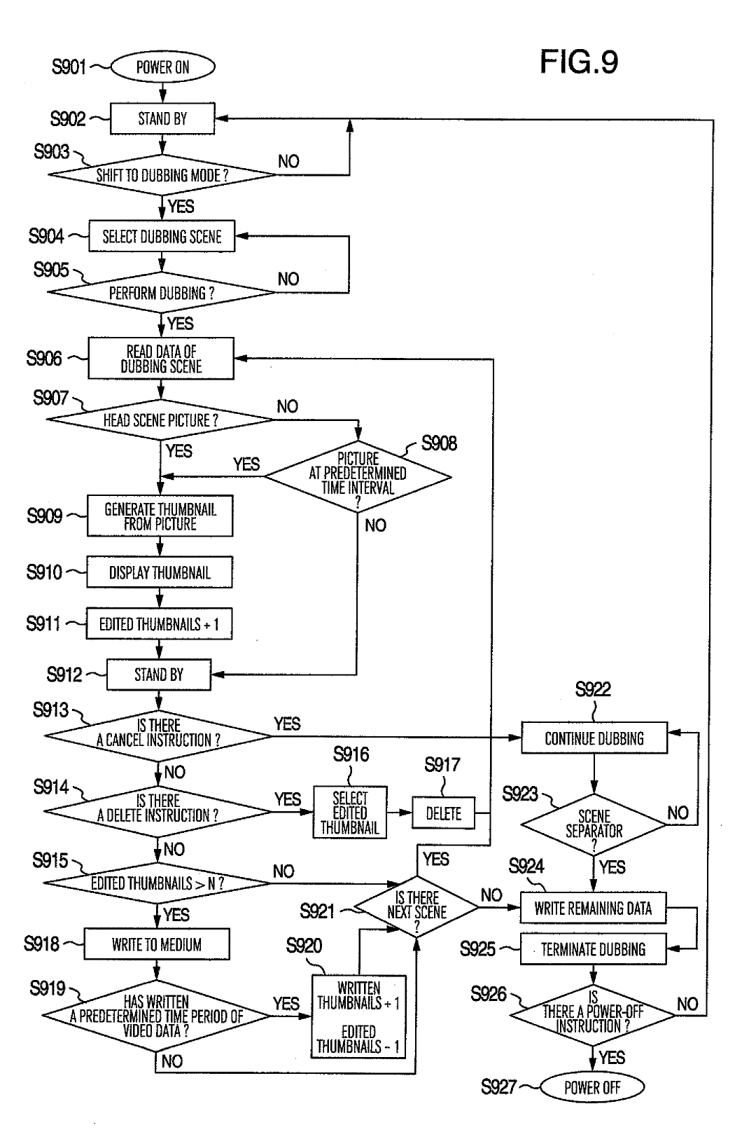

FIG. 9 shows a flowchart of the operations which the video camera performs from power ON to power OFF. The operations shown in the following flowchart will be described as performed under control of the CPU 10, the system control section 13, and the recording/reproducing processor 16.

Due to the power-up operation by a user, the video camera is powered ON (Step S901). When powered ON, the video camera becomes in a standby state to wait for an instruction from a user (Step S902). When there is an instruction to shift to the dubbing mode from a user, the video camera will shift to the dubbing mode (Step S903) and performs a dubbing scene selection process (Step S904). In this case, for the selection of a dubbing scene, for example, as shown in FIG. 3, a user may select from the dubbing scene selection screen, or the dubbing scene may be automatically selected on the video camera side. If there is an instruction to perform dubbing from a user, the dubbing process is started (Step S905). When the dubbing process is started, the recording/reproducing processor 16 reads video data from the image data storage area 21 of the HDD 20 (Step S906).

Also in the second embodiment, as with the first embodiment, the dubbing methods include the transcode dubbing method and the method of dubbing in the “as-is” format without changing the compression format. The present invention is applicable in either method, however, in the second embodiment, the latter method, i.e., the method of dubbing basically without performing the decoding/encoding process on the video data to be dubbed, is described. In this case, with regard to the video data for which a thumbnail should be generated, the decoding process is performed.

If the video data (hereinafter, referred to as a picture) read in Step S906 is a head picture of a scene (Step S907) or if it is a picture at a predetermined time interval (Step S908), a thumbnail is generated from the picture (Step S909) and the thumbnail is displayed (Step S910). The processes in decoding the picture and generating the thumbnail in this case are the same as those shown in the first embodiment, so the description is omitted. Moreover, in displaying a thumbnail in Step S910, if the screen being displayed in the display unit 18 is the one-screen dubbing display, a thumbnail larger than that of the multiple-screen dubbing display is displayed. Note that the thumbnail generated in Step S909 shall be stored in the thumbnail data storage area 22.

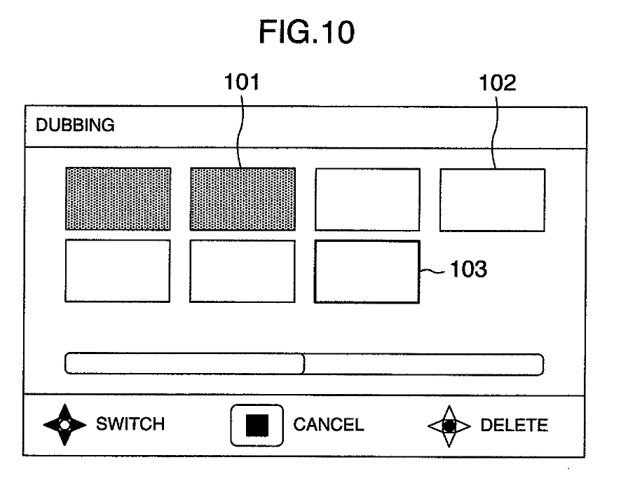

Here, the thumbnails that are displayed in dubbing in this embodiment include two types of thumbnails. One is a thumbnail (hereinafter, referred to as a write thumbnail), the writing of whose corresponding video scene to the optical disc has been started, and the other one is a thumbnail (hereinafter, referred to as an edit thumbnail), the writing of whose corresponding video scene to the optical disc has not been started. In FIG. 10, the write thumbnail is represented by reference numeral 101 and the edit thumbnail is represented by reference numeral 102. When a thumbnail is displayed in step S910, one edit thumbnail is added (Step S911).

Here, if there is a dubbing cancel instruction from a user (Step S913), the dubbing will be continued until reaching a scene separator (Step S922), and upon reaching the scene separator (Step S923) the dubbing process will be terminated (Step S924). Here, the scene separator is identified, for example, at a place where an entry point indicating that a chapter is complete is provided. Moreover, if there is a cancel instruction, a user may select until which scene to dub, from the edit thumbnails.

If there is a delete instruction (Step S914), a user selects a thumbnail corresponding to a scene to delete, from the edit thumbnails. A thumbnail selected by a user is deleted, and the writing of a corresponding scene to the optical disc is not performed and the dubbing process is continued again.

When the number of edit thumbnails displayed on the display screen is more than N (e.g., 5, etc.), the writing of a video scene to the optical disc is performed, while when the number of edit thumbnails is no more than N, if there is the next video data read from the image data storage area 21 of the HDD 20, the video camera will return to Step S906 without performing the writing to the optical disc, and the reading process of video scene data from the HDD 20 will be continued (Step S915). Thus, a user can, while confirming the edit thumbnail, determine whether or not the writing to the optical disc is performed and can easily perform more detailed dubbing.

When the writing to the optical disc is performed, it is determined whether or not the writing of a predetermined time period of video data has been performed (Step S919), and if the writing of a predetermined time period of video data has been performed, then one edit thumbnail is newly replaced with one write thumbnail on the display screen (Step S920).

When there is no video data to be read from the image data storage area 21 of the HDD 20 (Step S921), a scene corresponding to the remaining edit thumbnail is recorded to the optical disc (Step S924), and the dubbing process is terminated (Step S925). When there is a power OFF instruction from a user using a switch or the like provided in the video camera (Step S926), the video camera is powered OFF (Step S927).

In this way, by generating a thumbnail of a scene being dubbed at predetermined time intervals during dubbing, an effect of allowing a user to confirm the scene to be dubbed in more detail can be achieved with a simple configuration.

The edit thumbnails are controlled so that N or more edit thumbnails are always displayed, and a user can, after confirming an edit thumbnail, determine whether or not to dub a scene corresponding thereto, and if it is determined that this scene is not needed, then the user can issue the delete instruction or the cancel instruction. For this reason, a user can dub while confirming the content of a scene to dub in more detail. Moreover, a user can make effective use of the capacity of the optical disc without dubbing unnecessary information. Moreover, by shortening the time interval of generating a thumbnail (e.g., 5 seconds, 10 seconds, etc.), a user can appropriately skip the scene which he/she does not wish to leave, and can perform the dubbing to the optical disc.

FIG. 10 is a view showing an example of a screen display (hereinafter, referred to as a multiple-screen dubbing display) that is displayed on the user side in performing the dubbing processes of Step S905 to Step S920 of FIG. 9.

The thumbnails displayed on this screen include three types of thumbnails 101, 102, and 103. With regard to the thumbnails of pictures at predetermined time intervals and the thumbnail of the picture of a head scene, the thumbnails are sequentially generated and a newly generated thumbnail is displayed at the end of the display row. The half tone dot meshing thumbnail 101 is a thumbnail (a write thumbnail) corresponding to a scene whose writing to the optical disc has already been started. The thick-frame encircled thumbnail 103 indicates a thumbnail selected by a cursor. The thumbnail 102 is a thumbnail (an edit thumbnail) corresponding to a scene whose writing to the optical disc has not been started yet. A user can select a delete menu at the bottom and thereby delete a thumbnail selected among the edit thumbnails so that the writing of a scene corresponding to the deleted thumbnail to the optical disc can be prevented.

Moreover, by manipulating an up and down key at the bottom, a user can reciprocally perform display-switching between this multiple-screen dubbing display and the one-screen dubbing display in the first embodiment. In this case, in performing switching to the one-screen dubbing display, a process of enlarging the thumbnail is performed. When the switching from the one-screen dubbing display to the multiple-screen dubbing display is performed, the multiple-screen dubbing display is performed by reading the thumbnail data that were generated and stored in the thumbnail data storage area 22 in Step S909.

In this embodiment, a time lag (time difference) is provided after displaying a thumbnail of a corresponding video scene during dubbing and before starting the write to the optical disc. Furthermore, a write thumbnail and an edit thumbnail are marked and displayed in the display screen so as to be discriminated from each other. Accordingly, a user can dub while doing detailed editing, with a simple configuration.

Note that, the present invention is not limited to the above-described embodiments but includes various alternate embodiments. For example, the above embodiments have been described in detail in order to clearly explain the present invention, and the present invention is not necessarily limited to the embodiments including all the described configurations. Moreover, it is possible to replace a part of the configuration of a certain embodiment with a configuration of an alternative embodiment, and it is also possible to add a configuration of an alternative embodiment to the configuration of a certain embodiment.

1. An information recording and reproducing apparatus that records or reproduces image information to or from a recording medium, comprising:
a dubbing unit that reads image information recorded on a first recording medium and records the image information to a second recording medium;
a dubbing screen preparation unit that prepares a first display screen for displaying a thumbnail corresponding to image information that is recorded to the second recording medium by the dubbing unit, and a second display screen for displaying a thumbnail, whose corresponding image information is currently being recorded to the second recording medium by the dubbing unit; and
a switching unit which, during processing by the dubbing unit, switches and displays the first display screen and the second display screen prepared by the dubbing screen preparation unit.

2. The information recording and reproducing apparatus according to claim 1, further comprising a generator for generating a thumbnail at predetermined time intervals from image information that is read from the first recording medium by the dubbing unit, wherein
the first display screen prepared by the dubbing screen preparation unit displays a thumbnail generated by the generator.

3. The information recording and reproducing apparatus according to claim 1, further comprising a selector that selects a thumbnail corresponding to a piece of image information to be dubbed to the second recording medium by the dubbing unit, among pieces of image information recorded on the first recording medium, wherein
the first display screen prepared by the dubbing screen preparation unit displays a thumbnail selected by the selector.

4. The information recording and reproducing apparatus according to claim 1, wherein the second display screen prepared by the dubbing screen preparation unit displays a progress indicator indicative of a progress status of the entire dubbing.

5. The information recording and reproducing apparatus according to claim 1, wherein the first display screen prepared by the dubbing screen preparation unit distinguishes and displays a thumbnail corresponding to image information whose recording to the second recording medium has been started by the dubbing unit, and a thumbnail corresponding to image information whose recording to the second recording medium has not been started, so that a user can discriminate these thumbnails.

6. The information recording and reproducing apparatus according to claim 5, wherein in a state where reading of image information from the first recording medium has not been finished, among thumbnails displayed on the first display screen prepared by the dubbing screen preparation unit, if the number of thumbnails, the recording of whose corresponding image information to the second recording medium has not been started, is more than a predetermined number, then the dubbing unit records the image information to the second recording medium, while if the number of the thumbnails, the recording of whose corresponding image information to the second recording medium has not been started, is no more than the predetermined number, then the dubbing unit will not record the image information to the second recording medium.

7. The information recording and reproducing apparatus according to claim 1, further comprising a deleting unit that deletes a thumbnail corresponding to image information whose recording to the second recording medium has not been started, the thumbnail being displayed on the first display screen, wherein
the dubbing unit will not record image information to the second recording medium, the image information corresponding to a thumbnail that has been deleted by the deleting unit.

8. The information recording and reproducing apparatus according to claim 1, further comprising:
a cancel unit that cancels dubbing while the dubbing by the dubbing unit is performed; and
a selector which, when instructed to cancel dubbing by the cancel unit, selects to record, among thumbnails displayed on the first display screen, pieces of image information throughout a piece of image information corresponding to which thumbnail to the second recording medium.

9. The information recording and reproducing apparatus according to claim 1, wherein the first recording medium is a hard disc and the second recording medium is an optical disc.

10. An information recording and reproducing apparatus, comprising:
an encoding/decoding processing unit that performs an encoding process and a decoding process on image information;
a first recording and reproducing unit and a second recording and reproducing unit that record and reproduce a thumbnail for identifying encoding information on image information encoded by the encoding/decoding unit, and the image information, and management information on the image information;
a display screen preparation unit that performs image display processing of the image information, the thumbnail, and the management information of the image information;
a display unit for displaying an image processed by the display screen preparation unit;
an operation unit for selecting an arbitrary thumbnail from a plurality of thumbnails displayed on the display unit;
a dubbing control unit that dubs image information from the first recording and reproducing unit to the second recording and reproducing unit, the image information being identified by the arbitrary thumbnail selected by the operation unit;
a dubbing screen preparation unit which, during dubbing by the dubbing unit, prepares a first display screen which, with respect to all the thumbnails selected by the operation unit, displays a thumbnail of already dubbed image information and a thumbnail of image information whose dubbing has not been started, and a second display screen which displays a thumbnail for identifying image information currently being dubbed, detailed information on the image information, and a rate of progress relative to a period of the dubbing; and
a switching unit which, during dubbing by the dubbing control unit, switches and displays the first display screen and the second display screen prepared by the dubbing screen preparation unit.

11. The information recording and reproducing apparatus according to claim 10, wherein the encoding/decoding processing unit operates only under either encoding control or decoding control.

12. An information recording and reproducing apparatus that records or reproduces image information to or from a recording medium, comprising:
a dubbing unit that reads image information recorded on a first recording medium and records the image information to a second recording medium;
a generator for generating a thumbnail at predetermined time intervals from image information that is read from the first recording medium by the dubbing unit; and
a dubbing screen preparation unit that prepares a display screen for displaying a thumbnail generated by the generator, wherein
the display screen prepared by the dubbing screen preparation unit distinguishes and displays a thumbnail corresponding to image information whose recording to the second recording medium has been started by the dubbing unit, and a thumbnail corresponding to image information whose recording to the second recording medium has not been started, so that a user can discriminate these thumbnails.

13. The information recording and reproducing apparatus according to claim 12, wherein in a state where the reading of image information from the first recording medium has not been finished, among thumbnails displayed on the display screen prepared by the dubbing screen preparation unit, if the number of the thumbnails, the recording of whose corresponding image information to the second recording medium has not been started, is more than a predetermined number, then the dubbing unit records the image information to the second recording medium, while if the number of the thumbnails, the recording of whose corresponding image information to the second recording medium has not been started, is no more than the predetermined number, then the dubbing unit will not record the image information to the second recording medium.

14. The information recording and reproducing apparatus according to claim 12, further comprising a deleting unit that deletes a thumbnail corresponding to image information whose recording to the second recording medium has not been started, the thumbnail being displayed on the display screen, wherein
the dubbing unit will not record image information to the second recording medium, the image information corresponding to a thumbnail that has been deleted by the deleting unit.

15. The information recording and reproducing apparatus according to claim 12, further comprising:
a canceling unit that cancels dubbing while the dubbing by the dubbing unit is performed; and
a selector which, when instructed to cancel dubbing by the cancel unit, selects to record, among thumbnails displayed on the first display screen, pieces of image information throughout a piece of image information corresponding to which thumbnail to the second recording medium.

16. The information recording and reproducing apparatus according to claim 12, wherein the first recording medium is a hard disc and the second recording medium is an optical disc.
